(19) United States
(12) Patent Application Publication
(10) Pub. No.: US 2023/0080057 A1
(43) Pub. Date: Mar. 16, 2023

(54) SIMULATION METHOD OF SEMICONDUCTOR DEVICE, SIMULATION DEVICE OF SEMICONDUCTOR DEVICE, SIMULATION PROGRAM OF SEMICONDUCTOR DEVICE, AND DATA STRUCTURE

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Hiroshi YAMAMOTO, Minato Tokyo (JP); Kohei HASEGAWA, Yokohama Kanagawa (JP); Takuma HARA, Kanazawa Ishikawa (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 17/902,734

(22) Filed: Sep. 2, 2022

(30) Foreign Application Priority Data
Sep. 15, 2021 (JP) 2021-149934

(51) Int. Cl. G06F 30/367

(52) U.S. Cl. CPC G06F 30/367; H01L 29/7813

(57) ABSTRACT

A simulation method is a simulation method of a semiconductor device. The semiconductor device includes a first electrode, a second electrode, a semiconductor part located between the first electrode and the second electrode, an insulating member located inside the semiconductor part, a third electrode located inside the insulating member, and a fourth electrode located between the first electrode and the third electrode and located inside the insulating member. The method includes causing a value of a first resistance to change according to a value of a first voltage between the first electrode and the second electrode. The first resistance is connected between the second electrode and the fourth electrode.

### CROSS-REFERENCE TO RELATED APPLICATIONS

This application is based upon and claims the benefit of priority from Japanese Patent Application No. 2021-149934, filed on Sep. 15, 2021; the entire contents of which are incorporated herein by reference.

### FIELD

Embodiments described herein relate generally to a simulation method of a semiconductor device, a simulation device of a semiconductor device, a simulation program of a semiconductor device, and a data structure.

### BACKGROUND

In recent years, a FP-MOSFET that includes a gate electrode located inside a trench and a field plate electrode (FP) located below the gate electrode has been developed as a MOSFET (Metal-Oxide-Semiconductor Field-Effect Transistor) for power control. It is common to develop a FP-MOSFET while using a simulation to estimate the electrical characteristics. It is therefore desirable to increase the simulation accuracy.

### BRIEF DESCRIPTION OF THE DRAWINGS

FIG. 1 is a block diagram showing a simulation device according to a first embodiment;

FIG. 2 is a cross-sectional view showing a semiconductor device that is an object of the simulation according to the first embodiment;

FIG. 3 is a graph showing an operation of the semiconductor device, in which the horizontal axis is a time, and the vertical axis is a drain-source voltage V_{DS} and a drain-source current I_{d};

FIG. 4 is a drawing in which components of an equivalent circuit are overlaid on the semiconductor device shown in FIG. 2;

FIG. 5 is a circuit diagram showing an equivalent circuit assumed in the simulation according to the first embodiment;

FIG. 6 is a graph showing a relationship between the voltage V_{DS} and a resistance R_{DS(OFF)} according to the first embodiment, in which the horizontal axis is the drain-source voltage V_{DS}, and the vertical axis is the drain-source resistance R_{DS(OFF)};

FIG. 7 shows the simulation method according to the first embodiment;

FIG. 8 is a graph showing a relationship between a voltage V_{DS} and a resistance R_{DS(OFF)} according to a second embodiment, in which the horizontal axis is a drain-source voltage V_{DS}, and the vertical axis is a drain-source resistance R_{DS(OFF)};

FIG. 9 shows a simulation method according to a third embodiment;

FIG. 10 is a circuit diagram showing a resistive load switching circuit used in a test example; and

FIGS. 11A to 11C are graphs showing results of the test example, in which the horizontal axis is a time, and the vertical axis is a drain-source voltage V_{DS} and a drain-source current I_{d}.

### DETAILED DESCRIPTION

In general, a simulation method according to one embodiment is a simulation method of a semiconductor device. The semiconductor device includes a first electrode, a second electrode, a semiconductor part located between the first electrode and the second electrode, an insulating member located inside the semiconductor part, a third electrode located inside the insulating member, and a fourth electrode located between the first electrode and the third electrode and located inside the insulating member. The semiconductor part includes a first semiconductor layer connected to the first electrode, a second semiconductor layer connected to the second electrode, and a third semiconductor layer contacting the first and second semiconductor layers. The first semiconductor layer is of a first conductivity type. The second semiconductor layer is of the first conductivity type. The third semiconductor layer is of a second conductivity type. The method includes causing a value of a first resistance to change according to a value of a first voltage between the first electrode and the second electrode. The first resistance is connected between the second electrode and the fourth electrode.

### First Embodiment

The embodiment is a simulation device, a simulation method, a simulation program, and a data structure used in a simulation that estimate an operation of a semiconductor device.

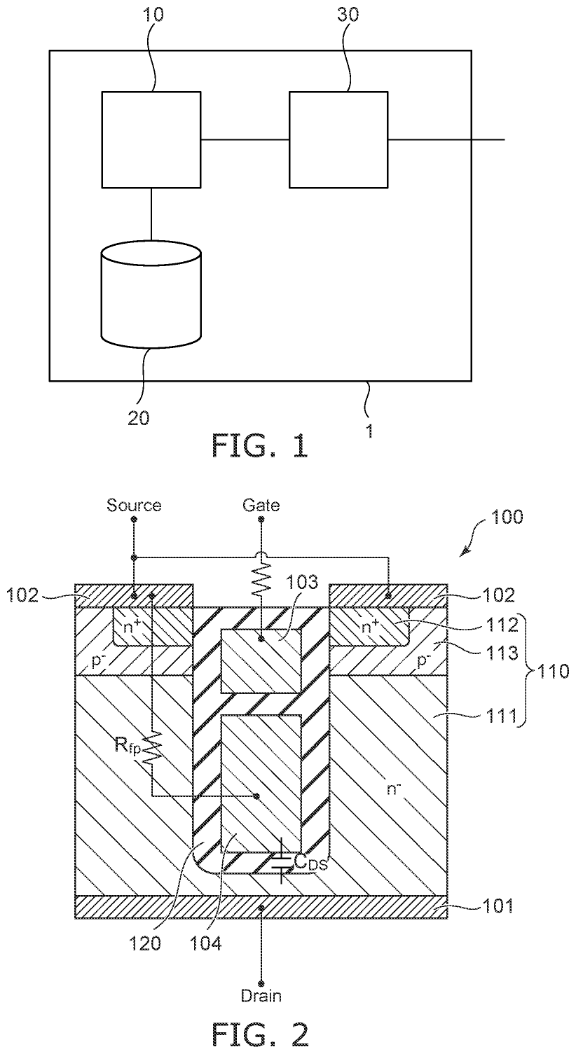

FIG. 1 is a block diagram showing a simulation device according to the embodiment.

As shown in FIG. 1, the simulation device 1 according to the embodiment includes a calculation part 10, storage 20, and an input/output part 30. The calculation part 10 includes, for example, a CPU (Central Processing Unit). The storage 20 includes, for example, a SSD (Solid State Drive) or a HDD (Hard Disk Drive). The input/output part 30 includes, for example, an interface unit such as a keyboard, a display, etc., and a communication unit with the outside such as various cable terminals wireless devices, etc. The calculation part 10 is connected to the storage 20 and the input/output part 30. A simulation program described below is stored in the storage 20.

A semiconductor device that is the object of the simulation according to the embodiment will now be described.

FIG. 2 is a cross-sectional view showing the semiconductor device that is the object of the simulation according to the embodiment.

According to the embodiment as shown in FIG. 2, the semiconductor device 100 that is the object of the simulation is a field plate MOSFET. The semiconductor device 100 includes a drain electrode 101 (a first electrode), a source electrode 102 (a second electrode), a gate electrode 103 (a third electrode) a field plate (FP) electrode 104 (a fourth electrode), a semiconductor part 110, and an insulating member 120. Although the semiconductor device 100 is an n-channel MOSFET (nMOS) in the example below, the semiconductor device 100 may be a p-channel MOSFET (pMOS).

In FIG. 2, among the external terminals connected to the semiconductor device 100, a drain terminal connected to the drain electrode 101 is labeled “Drain”; the source terminal connected to the source electrode 102 is labeled “Source”; and the gate terminal connected to the gate electrode 103 is labeled “Gate”. This is similar for the other drawings described below as well.

The semiconductor part 110 is located between the drain electrode 101 and the source electrode 102. The insulating member 120 is located inside the semiconductor part 110. The insulating member 120 reaches the surface of the semiconductor part 110 at the source electrode 102 side (the upper surface) but does not reach the surface of the semiconductor part 110 at the drain electrode 101 side (the lower surface). The gate electrode 103 is located inside the insulating member 120. The FP electrode 104 is located between the drain electrode 101 and the gate electrode 103 inside the insulating member 120.

The insulating member 120, the gate electrode 103, and the FP electrode 104 extend linearly in a direction (hereinbelow, also called the “trench direction”) perpendicular to the page surface of FIG. 1. The gate electrode 103 and the FP electrode 104 are insulated from the semiconductor part 110 and insulated from each other by the insulating member 120. The FP electrode 104 is connected to the source electrode 102 by being drawn out above the semiconductor part 110 at a position in the depth direction or the front direction of the page surface of FIG. 1. In the specification, “connected” means an electrical connection.

The semiconductor part 110 includes a drift layer 111 (a first semiconductor layer), a source layer 112 (a second semiconductor layer), and a base layer 113 (a third semiconductor layer). The drift layer 111 is connected to the drain electrode 101; and the conductivity type of the drift layer 111 is the n⁻-type. The source layer 112 is connected to the source electrode 102; and the conductivity type of the source layer 112 is the n⁺-type. The carrier concentration of the source layer 112 is greater than the carrier concentration of the drift layer 111. The base layer 113 is located between the drift layer 111 and the source layer 112 and contacts the drift layer 111, the source layer 112, and the source electrode 102. The conductivity type of the base layer 113 is the p⁻-type. The drift layer 111 and the source layer 112 are separated from each other with the base layer 113 interposed. When the semiconductor device 100 is a pMOS, the n-type and the p-type described above are reversed.

A basic operation of the semiconductor device 100 will now be described.

In the semiconductor device 100, a drain-source voltage V_{DS} is applied with the drain electrode 101 as the positive pole and the source electrode 102 as the negative pole. Thereby, a depletion layer is caused to spread with the p-n interface between the drift layer 111 and the base layer 113 as a starting point. When a potential that is greater than a threshold is applied to the gate electrode 103 in this state, an n-type inversion layer is formed in the part of the base layer 113 contacting the insulating member 120. Thereby, the semiconductor device 100 is switched to the “on-state”; and a current flows between the drain electrode 101 and the source electrode 102. On the other hand, the inversion layer disappears when a potential that is less than the threshold is applied to the gate electrode 103. Thereby, the semiconductor device 100 is switched to the “off-state”; and the current between the drain electrode 101 and the source electrode 102 is blocked.

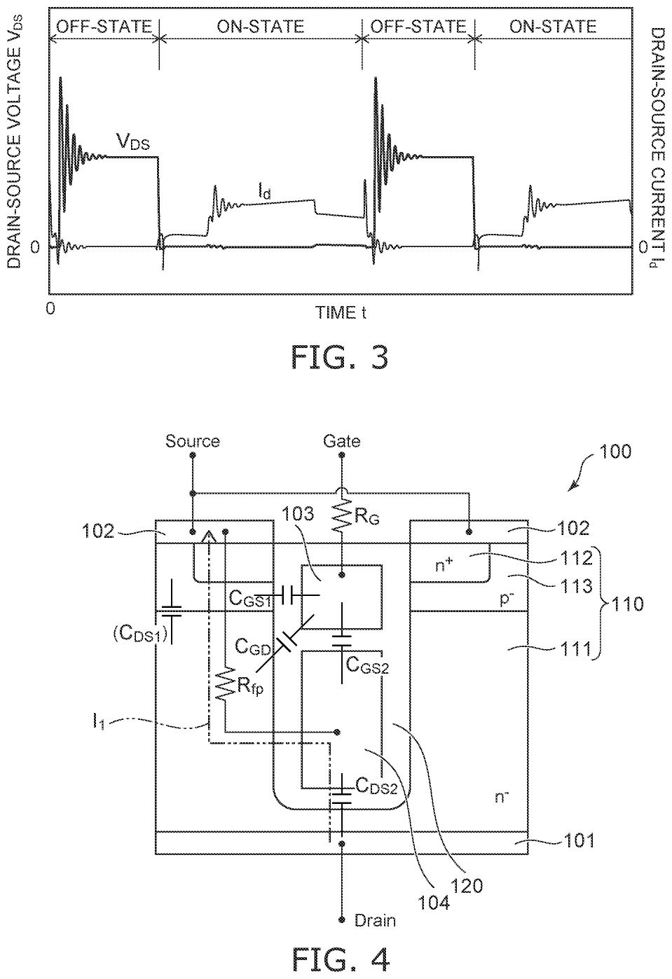

FIG. 3 is a graph showing the operation of the semiconductor device 100, in which the horizontal axis is the time, and the vertical axis is the drain-source voltage V_{DS} and a drain-source current I_{d}.

As shown in FIG. 3, when the semiconductor device 100 is switched from the on-state to the off-state, the drain-source voltage V_{DS} increases from zero and oscillates. The oscillation of the voltage V_{DS} attenuates over time and eventually converges to a constant value. It is important to control the oscillation when designing the semiconductor device 100.

An equivalent circuit of the semiconductor device 100 assumed in the simulation of the embodiment will now be described.

FIG. 4 is a drawing in which components of the equivalent circuit are overlaid on the semiconductor device shown in FIG. 2.

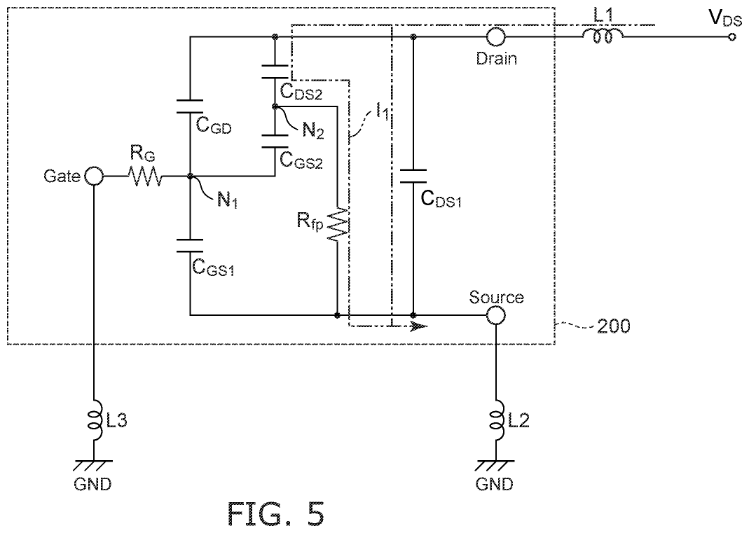

FIG. 5 is a circuit diagram showing the equivalent circuit assumed in the simulation according to the embodiment.

According to the embodiment as shown in FIG. 4, the resistance between the source electrode 102 and the FP electrode 104 is a resistance R_{fp} (a first resistance). The resistance R_{fp} is the resistance of the FP electrode 104 itself in a direction (the trench direction) perpendicular to the page surface of FIG. 1.

The capacitance between the drain electrode 101 and the source electrode 102 is a capacitance C_{DS1} (a first capacitance). The capacitance between the drain electrode 101 and the gate electrode 103 is a capacitance C_{GD} (a second capacitance). The capacitance between the source electrode 102 and the gate electrode 103 is a capacitance C_{GS1} (a third capacitance). The resistance of the gate electrode 103 itself in the trench direction is a resistance R_{G} (a second resistance). The capacitance between the drain electrode 101 and the FP electrode 104 is a capacitance C_{DS2} (a fourth capacitance). The capacitance between the gate electrode 103 and the FP electrode 104 is a capacitance C_{GS2} (a fifth capacitance).

When the voltage between the source electrode 102 and the FP electrode 104 oscillates, that is, when the voltage includes an AC component, a current flows not only in the interconnect that connects the FP electrode 104 to the source electrode 102 but also in a current path I₁ from the FP electrode 104 to the source electrode 102 via the insulating member 120, the drift layer 111, and the base layer 113. The current path I₁ appears when the semiconductor device 100 is in the off-state; and the current path I₁ does not pass through the inversion layer.

When the semiconductor device 100 is in the off-state, the resistance of a current path I₀ (not illustrated) from the drain electrode 101 to the source electrode 102 is a resistance R_{DS(OFF)}. The resistance R_{DS(OFF)} includes a combined resistance component of the resistance R_{fp} and the impedance of the capacitances C_{DS1} and C_{DS2} that are parasitic capacitances at the periphery of the resistance R_{fp}. The current path I₀ includes the current path I₁. The current path I₁ passes through the depletion layer formed between the drift layer 111 and the base layer 113. The resistance R_{DS(OFF)} is dependent on the voltage V_{DS} (the first voltage) between the drain electrode 101 and the source electrode 102 because the thickness of the depletion layer is dependent on the voltage V_{DS}. Specifically, as the voltage V_{DS} increases, the thickness of the depletion layer increases and the resistance R_{DS(OFF)} increases. Because the capacitance C_{DS1} also is dependent on the thickness of the depletion layer, the capacitance C_{DS1} is dependent on the voltage V_{DS}. Specifically, as the voltage V_{DS} increases, the thickness of the depletion layer increases and the capacitance C_{DS1} decreases.

As shown in FIG. 5, an equivalent circuit 200 of the semiconductor device 100 includes a drain terminal, a source terminal, and a gate terminal. The equivalent circuit 200 also includes the resistance R_{fp}, the capacitance C_{DS1}, the capacitance C_{GD}, the capacitance C_{GS1}, the resistance R_{G}, the capacitance C_{DS2}, and the capacitance C_{GS2}. As described above, the resistance R_{DS(OFF)} (not illustrated) is a combination of the resistance R_{fp}, the capacitance C_{DS1}, and the capacitance C_{GS2}.

The capacitance C_{DS1} (the first capacitance) is connected between the drain terminal and the source terminal. The capacitance C_{GD} (the second capacitance) is connected between the drain terminal and the gate terminal. The capacitance C_{GS1} (the third capacitance) is connected between the source terminal and the gate terminal. The resistance R_{G} (the second resistance) connected between the gate terminal and a connection point N₁ between the capacitance C_{GD} and the capacitance C_{GS1}. The capacitance C_{DS2} (the fourth capacitance) is connected to the drain terminal. The capacitance C_{GS2} (the fifth capacitance) is connected to the connection point N₁. The resistance R_{fp} (the first resistance) is connected between the source terminal and a connection point N₂ between the capacitance C_{DS2} and the capacitance C_{GS2}. The connection point N₂ corresponds to the FP electrode 104.

Inductances L1, L2, and L3 are components included in the equivalent circuit of the package in which the semiconductor device 100 is mounted. The inductances L1, L2, and L3 each are outside the equivalent circuit 200.

As described above, the resistance R_{fp} is dependent on the voltage V_{DS}; and the resistance R_{fp} increases as the voltage V_{DS} increases.

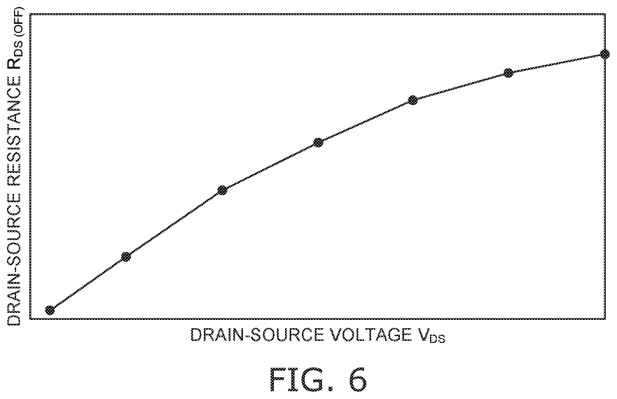

FIG. 6 is a graph showing a relationship between the voltage V_{DS} and the resistance R_{DS(OFF)} according to the embodiment, in which the horizontal axis is the drain-source voltage V_{DS}, and the vertical axis is the drain-source resistance R_{DS(OFF)}.

In FIG. 6, actual measured values are shown by black circles (●), and an approximation formula is shown by a curve.

Formula 1 below is used as the approximation formula of FIG. 6. Formula 1 below is a quadratic equation.

R_{DS(OFF)}=a×V_{DS}²+b×V_{DS}+c [Formula 1]

In Formula 1 above, “a”, “b”, and “c” are coefficients. For example, the coefficient a is −9×10⁻⁵, the coefficient b is 0.0128, and the coefficient c is −0.0135. Substituting these coefficients in Formula 1 above gives the following Formula 2.

R_{DS(OFF)}=−9×10⁻⁵×V_{DS}²+0.0128×V_{DS}−0.0135 [Formula 2]

Operations of the simulation device according to the embodiment, i.e., the simulation method according to the embodiment, will now be described.

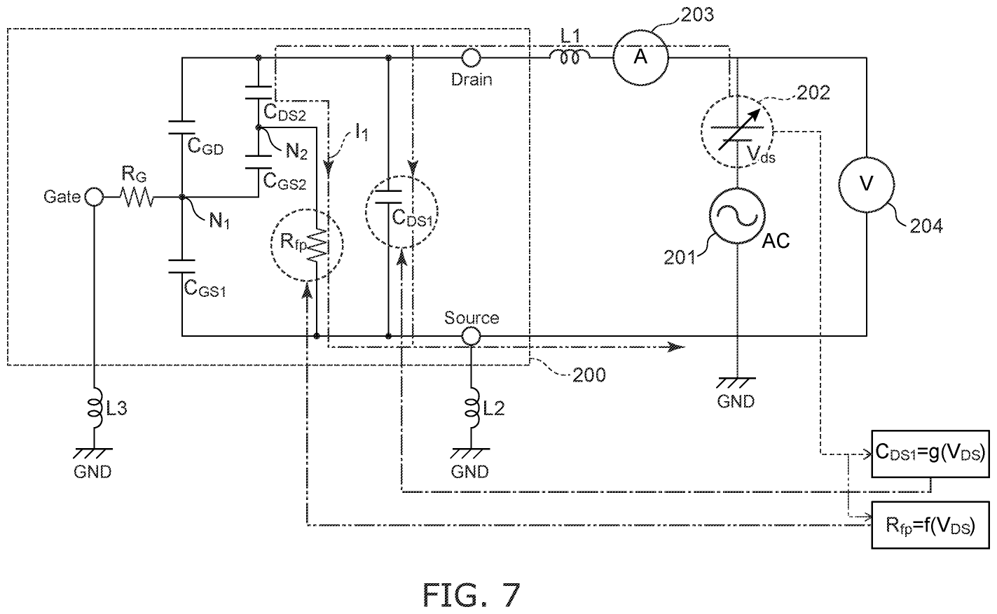

FIG. 7 shows the simulation method according to the embodiment.

As shown in FIG. 7, the simulation method according to the embodiment simulates the operations of the semiconductor device 100 (see FIG. 2). The storage 20 of the simulation device 1 (see FIG. 1) stores a simulation program assuming the equivalent circuit 200 of the semiconductor device 100 (see FIG. 5), a relationship between the voltage V_{DS} and the resistance R_{fp}, and a relationship between the voltage V_{DS} and the capacitance C_{DS1}.

In the simulation, an AC power supply 201, a DC power supply 202, and an ammeter 203 are assumed outside the equivalent circuit 200 and are connected in series between the source electrode 102 and the drain electrode 101. Also, a voltmeter 204 that is connected in parallel with a circuit made of the AC power supply 201 and the DC power supply 202 is assumed.

In the simulation method according to the embodiment, instead of the drain-source resistance R_{DS(OFF)}, the resistance R_{fp} is caused to change according to the voltage V_{DS}. As described above, although the resistance R_{fp} is normally constant, for convenience in the simulation, the resistance R_{fp} is caused to change according to the voltage V_{DS} so that the simulation reflects the fluctuation of the resistance R_{DS(OFF)} according to the voltage V_{DS}. The capacitance C_{DS1} also changes because the capacitance C_{DS1} fluctuates according to the voltage V_{DS}.

For example, the relationship between the voltage V_{DS} and the resistance R_{fp} is stored in the form of the function R_{fp}=f(V_{DS}). For example, the relationship between the voltage V_{DS} and the capacitance C_{DS1} is stored in the form of the function C_{DS1}=g(V_{DS}). The function R_{fp}=f(V_{DS}) is, for example, the formula in which R_{DS(OFF)} is replaced with R_{fp} in Formula 1 above, and, for example, the formula in which R_{DS(OFF)} is replaced with R_{fp} in Formula 2 above.

As shown in FIG. 5, the potential of the gate electrode 103 is set to a ground potential GND in the simulation method according to the embodiment. The case where the semiconductor device 100 is in the off-state is simulated thereby.

The calculation part 10 reads the simulation program from the storage 20 and executes the simulation program. For example, the simulation program according to the embodiment is a program based on SPICE (Simulation Program with Integrated Circuit Emphasis) and simulates the operation of the equivalent circuit 200. In the simulation program, the voltage V_{DS} is set as the output of the DC power supply 202. The simulation program calculates the value of the resistance R_{fp} based on the value of the voltage V_{DS} using the function R_{fp}=f(V_{DS}), and calculates the value of the capacitance C_{DS1} based on the value of the voltage V_{DS} using the function C_{DS1}=g(V_{DS}). The operation of the semiconductor device 100 is simulated by repeating these calculations.

Effects of the embodiment will now be described.

According to the embodiment, the resistance R_{fp} between the source electrode 102 and the FP electrode 104 is calculated based on the drain-source voltage V_{DS}. The change of the resistance R_{DS(OFF)} caused by the change of the voltage V_{DS} can be calculated thereby, and the oscillation of the voltage V_{DS} shown in FIG. 3 can be accurately reproduced.

According to the embodiment, the capacitance C_{DS1} is calculated based on the voltage V_{DS}. The change of the capacitance C_{DS1} caused by the change of the voltage V_{DS} can be calculated thereby, and the oscillation of the voltage V_{DS} shown in FIG. 3 can be more accurately reproduced.

### Second Embodiment

The formula of the relationship between the voltage V_{DS} and the resistance R_{DS(OFF)} according to the embodiment is different from that of the first embodiment.

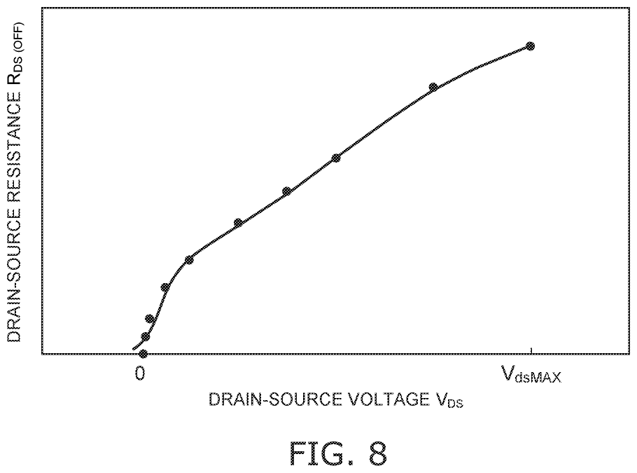

FIG. 8 is a graph showing the relationship between the voltage V_{DS} and the resistance R_{DS(OFF)} according to the embodiment, in which the horizontal axis is the drain-source voltage V_{DS}, and the vertical axis is the drain-source resistance R_{DS(OFF)}.

In FIG. 8, actual measured values are shown by black circles (●), and an approximation formula is shown by a curve.

The following Formula 3 is used as the approximation formula of FIG. 8. Formula 3 is a function including the activation function tanh (the hyperbolic tangent function).

$${R}_{DS ( OFF )} = \text{?} \{ d + e \times tanh ( 2 \frac{{V}_{ds}}{{V}_{dsMAX}} + f ) \} \{ g tanh ( h \frac{{V}_{ds}}{{V}_{dsMAX}} + i ) \} \qquad [ Formula 3 ]$$

$$\text{?} \text{indicates text missing or illegible when filed}$$

“V_{dsMAX}” shown in FIG. 8 and Formula 3 above represents the breakdown voltage of the semiconductor device 100. “R_{fp@0.5VdsMAX}” represents the value of the resistance R_{fp} when the voltage V_{DS} is half of the breakdown voltage (V_{dsMAX}) of the semiconductor device 100. “d”, “e”, “f”, “g”, “h”, and “i” are coefficients. For example, the coefficient d is +1, the coefficient e is ¾, the coefficient f is −1, the coefficient g is +1, the coefficient h is +20, and the coefficient i is −1. Substituting these coefficients into Formula 3 above gives the following Formula 4.

$${R}_{DS ( OFF )} = \text{?} \{ 1 + \frac{3}{4} tanh ( 2 \frac{{V}_{ds}}{{V}_{dsMAX}} - 1 ) \} \{ 1 tanh ( 20 \frac{{V}_{ds}}{{V}_{dsMAX}} - 1 ) \} \qquad [ Formula 4 ]$$

$$\text{?} \text{indicates text missing or illegible when filed}$$

Otherwise, the configuration, operations, and effects according to the embodiment are similar to those of the first embodiment.

### Third Embodiment

The embodiment differs from the first and second embodiments in that the relationship between the voltage V_{DS} and the resistance R_{fp} and the relationship between the voltage V_{DS} and the capacitance C_{DS1} are realized as a data structure.

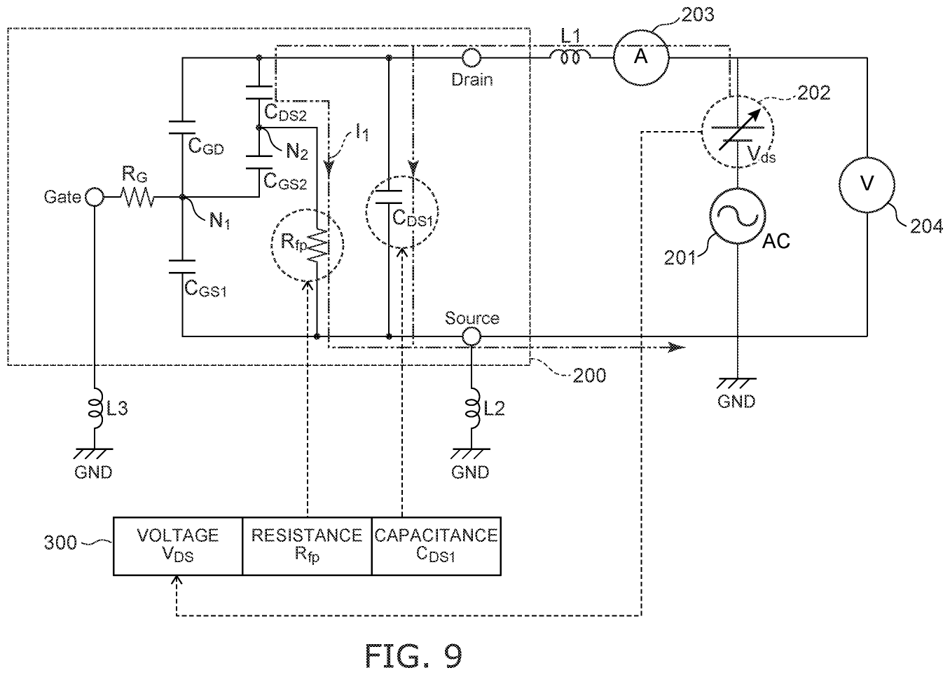

FIG. 9 shows the simulation method according to the embodiment.

According to the embodiment as shown in FIG. 9, the equivalent circuit 200 and a data structure 300 are stored in the storage 20 of the simulation device 1 (see FIG. 1). In the data structure 300, multiple values of the voltage V_{DS}, multiple values of the resistance R_{fp}, and multiple values of the capacitance C_{DS1} are associated with each other and stored. In other words, the data structure 300 indicates the relationship between the voltage V_{DS} and the resistance R_{fp} and the relationship between the voltage V_{DS} and the capacitance C_{DS1}.

When the calculation part 10 of the simulation device 1 (see FIG. 1) acquires the value of the voltage V_{DS} in the simulation of the equivalent circuit 200, the calculation part 10 refers to the data structure 300, reads the value of the capacitance C_{DS1} and the value of the resistance R_{fp} corresponding to the value of the voltage V_{DS}, and feeds back the values to the simulation of the equivalent circuit 200. Then, the simulation of the equivalent circuit 200 is performed using the value of the resistance R_{fp} and the value of the capacitance C_{DS1} that are newly read. The operation of the semiconductor device 100 is simulated by repeating.

According to the embodiment, using the data structure 300 enable a faster simulation of the semiconductor device 100. Otherwise, the configuration, operations, and effects according to the embodiment are similar to those of the first embodiment.

### Test Example

A test example that shows the effects of the first embodiment will now be described.

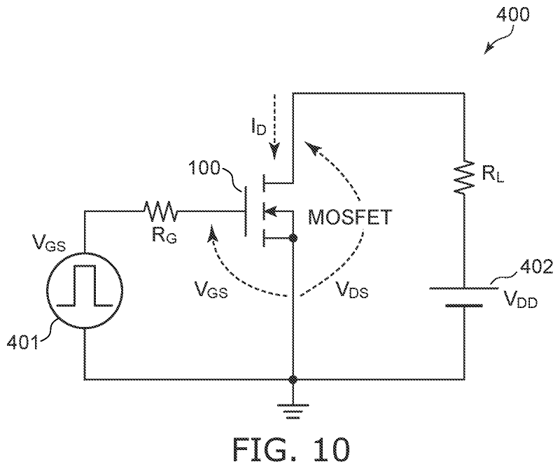

FIG. 10 is a circuit diagram showing the resistive load switching circuit used in the test example.

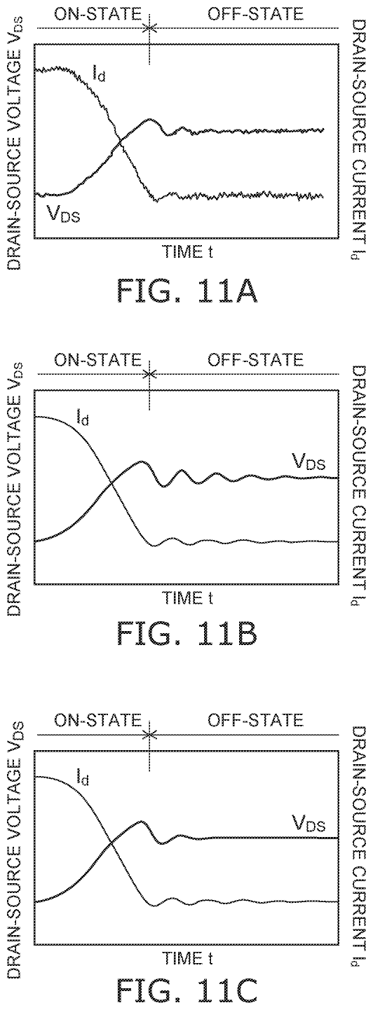

FIGS. 11A to 11C are graphs showing results of the test example, in which the horizontal axis is the time, and the vertical axis is the drain-source voltage V_{DS} and the drain-source current I_{d}.

In the test example as shown in FIG. 10, the source electrode 102 of the semiconductor device 100 is connected to the ground potential GND in the resistive load switching circuit 400 that is used. The resistance R_{G} and a signal output circuit 401 are connected in series between the gate electrode 103 and the source electrode 102 of the semiconductor device 100. A resistive load R_{L} and a DC power supply 402 are connected in series between the drain electrode 101 and the source electrode 102 of the semiconductor device 100.

FIG. 11A shows actual measurement results. The actual measurement results shown in FIG. 11A are actual measurements using the resistive load switching circuit 400 shown in FIG. 10. As shown in FIG. 11A, the drain-source voltage V_{DS} oscillated when the semiconductor device was turned off.

FIG. 11B shows simulation results of a comparative example. The value of the resistance R_{fp} is a fixed value in the comparative example.

FIG. 11C shows simulation results of the first embodiment. According to the first embodiment as described above, the value of the resistance R_{fp} was caused to change according to the value of the voltage V_{DS}.

As shown in FIGS. 11A to 11C, the simulation results of the first embodiment were closer to the actual measurement results than the comparative example.

According to embodiments described above, a simulation method of a semiconductor device, a simulation device of a semiconductor device, a simulation program of a semiconductor device, and a data structure can be realized in which the accuracy can be increased.

Although the calculation part 10 of the simulation device 1 executes a simulation program stored in the storage 20 in the example according to the embodiments described above, the execution is not limited thereto. For example, the calculation part 10 may execute a simulation program existing in a cloud, or the execution of the program itself may be performed in a cloud.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A simulation method of a semiconductor device,
the semiconductor device including:
a first electrode;
a second electrode;
a semiconductor part located between the first electrode and the second electrode;
an insulating member located inside the semiconductor part;
a third electrode located inside the insulating member; and
a fourth electrode located between the first electrode and the third electrode and located inside the insulating member,
the semiconductor part including:
a first semiconductor layer connected to the first electrode, the first semiconductor layer being of a first conductivity type;
a second semiconductor layer connected to the second electrode, the second semiconductor layer being of the first conductivity type; and
a third semiconductor layer contacting the first and second semiconductor layers, the third semiconductor layer being of a second conductivity type,
the method comprising:
causing a value of a first resistance to change according to a value of a first voltage between the first electrode and the second electrode, the first resistance being connected between the second electrode and the fourth electrode.

2. The method according to claim 1, wherein
the value of the first resistance increases as the value of the first voltage increases.

3. The method according to claim 1, wherein
the value of the first resistance is calculated by a formula including the first voltage.

4. The method according to claim 3, wherein
the formula is a quadratic equation.

5. The method according to claim 3, wherein
the formula includes an activation function.

6. The method according to claim 1, wherein
the value of the first resistance that corresponds to the value of the first voltage is acquired by referring to a data structure, and
the data structure includes a correspondence between the value of the first voltage and the value of the first resistance.

7. The method according to claim 1, wherein
the method assumes an equivalent circuit including
a first capacitance connected between the first electrode and the second electrode,
a second capacitance connected between the first electrode and the third electrode,
a third capacitance connected between the second electrode and the third electrode,
a second resistance connected between the third electrode and a first connection point, the first connection point being between the second capacitance and the third capacitance,
a fourth capacitance connected to the first electrode, and
a fifth capacitance connected to the first connection point,
the first resistance being connected between the second electrode and a second connection point, the second connection point being between the fourth capacitance and the fifth capacitance.

8. The method according to claim 7, wherein
the first capacitance decreases as the first voltage increases.

9. A simulation device of a semiconductor device,
the semiconductor device including:
a first electrode;
a second electrode;
a semiconductor part located between the first electrode and the second electrode;
an insulating member located inside the semiconductor part;
a third electrode located inside the insulating member; and
a fourth electrode located between the first electrode and the third electrode and located inside the insulating member,
the semiconductor part including:
a first semiconductor layer connected to the first electrode, the first semiconductor layer being of a first conductivity type;
a second semiconductor layer connected to the second electrode, the second semiconductor layer being of the first conductivity type; and
a third semiconductor layer contacting the first and second semiconductor layers, the third semiconductor layer being of a second conductivity type,
the simulation device causing a value of a first resistance to change according to a value of a first voltage between the first electrode and the second electrode,
the first resistance being connected between the second electrode and the fourth electrode.

10. A simulation program of a semiconductor device,
the semiconductor device including:
a first electrode;
a second electrode;
a semiconductor part located between the first electrode and the second electrode;
an insulating member located inside the semiconductor part;
a third electrode located inside the insulating member; and
a fourth electrode located between the first electrode and the third electrode and located inside the insulating member,
the semiconductor part including:
a first semiconductor layer connected to the first electrode, the first semiconductor layer being of a first conductivity type;
a second semiconductor layer connected to the second electrode, the second semiconductor layer being of the first conductivity type; and
a third semiconductor layer contacting the first and second semiconductor layers, the third semiconductor layer being of a second conductivity type,
the simulation program causing a computer to acquire a value of a first resistance based on a first voltage between the first electrode and the second electrode,
the first resistance being connected between the second electrode and the fourth electrode.

11. A data structure used in a simulation of a semiconductor device,
the semiconductor device including:
a first electrode;
a second electrode;
a semiconductor part located between the first electrode and the second electrode;
an insulating member located inside the semiconductor part;
a third electrode located inside the insulating member; and
a fourth electrode located between the first electrode and the third electrode and located inside the insulating member,
the semiconductor part including:
a first semiconductor layer connected to the first electrode, the first semiconductor layer being of a first conductivity type;
a second semiconductor layer connected to the second electrode, the second semiconductor layer being of the first conductivity type; and
a third semiconductor layer contacting the first and second semiconductor layers, the third semiconductor layer being of a second conductivity type,
the data structure comprising:
a value of a first voltage between the first electrode and the second electrode; and
a value of a first resistance corresponding to the value of the first voltage,
the first resistance being connected between the second electrode and the fourth electrode.
